(19) United States
(12) Patent Application Publication
(10) Pub. No.: US 2014/0244019 A1
(43) Pub. Date: Aug. 28, 2014

(54) System and Method for Bill-of-Materials Low-Level Code Harmonization

(71) Applicant: SAP AG, Walldorf (DE)

(72) Inventors: Eryi Zhang, Heidelberg (DE); Philippe Drouin, Sinsheim (DE); Uwe Frankenhauser, Leimen (DE); Andreas Stier, Malsch (DE); Jochen Thierer, Bruchsal (DE)

(73) Assignee: SAP AG, Walldorf (DE)

(21) Appl. No.: 13/773,914

(22) Filed: Feb. 22, 2013

(51) Int. Cl. G06F 17/00

(52) U.S. Cl. CPC G06F 17/00
USPC 700/107

(57) ABSTRACT

Techniques for bill of material (BOM) low-level code harmonization are disclosed. The BOMs from different sources for each product are ranked according to corresponding low-level codes of the end product. The BOMs are scanned in order to determine the lowest low-level code for all BOMs for a particular product. The BOMs for the particular product are then associated with the lowest low-level code. Once all the BOMs for each product are assigned the lowest low-level code for that product, then the BOMs are rescanned in the ranked order to determine the lowest low-level code associated with each end product in BOMs in which the end products are included as components. Each BOM for each end product is then associated with lowest low-level code from the BOM in which the end product is listed as a component. The harmonized low-level codes are used for determination of eligibility for preferential customs duties.

### BACKGROUND

The present invention relates to processing manufacturing codes for bills of materials (BOMs) for determination of eligibility for preferential customs duties, and in particular, to systems and methods for automatically harmonizing low-level codes of mixed origin BOMs for customs compliance of preference determinations.

Unless otherwise indicated herein, the approaches described in this section are not prior art to the claims in this application and are not admitted to be prior art by inclusion in this section.

In product planning and manufacturing, the list of components or materials to a particular end product is referred to as the bill of materials (BOM). The BOM can identify the components, i.e., materials and subparts, of a product and describe the sequential relationship of the components with one another for any particular product and assembly process. For accounting, manufacturing, and legal compliance purposes, the components or materials listed in a BOM for a particular product can be coded in different ways to indicate various characteristics of the product and/or the components. Once the components for the particular product are coded, the codes can be easily and quickly referenced to determine various product characteristics for manufacturing planning, e.g., sourcing and delivery, or legal requirements, e.g., determination of eligibility for preferential customs duty.

For example, FIG. 1 illustrates manufacturing level codes 100 for product A, and various components of a product A, generated from a manufacturing process perspective. Product A is coded as being in the manufacturing level 0, shown at 111. Product A is manufactured from products B and C. Products B and C are coded as being in the manufacturing level 1 shown at 112. Product B is manufactured from products D and C. In the particular example shown, products D and C are coded as being in manufacturing level 2. From the manufacturing point of view, product B would need to be produced before product A could be produced. Similarly, products D and C would need to be produced before product B could be produced. Accordingly, because products D and C are coded as being in manufacturing level 2, users and planning systems can quickly determine that products D and C need to be produced prior to any related products, such as product B, coded as being in manufacturing level 1, can be produced. Any products coded as being in manufacturing level 1 and/or 2 would need to be produced prior to any related product coded as being in manufacturing level 1, such as product A. While manufacturing codes 100 are useful for manufacturing planning purposes, for regulatory or other legal compliance purposes, other users and systems may need to have the products A, B, C, and D coded in different ways according to different perspectives of the product structure.

For example, for purposes of determining customs duties, a product structure can be coded in a way that helps users and systems to determine whether or not the end product qualifies for preferential customs duty. The determination as to whether a product qualifies for preferential customs duty is sometimes referred to as a preference determination. Typically, the preference determination depends heavily on the coding associated with the manufacturing levels of a particular product structure. Many preference determinations for a particular product can be made based on manufacturing level at which a component or material in a bill of materials (BOM) for the product appears in the manufacturing process. The lowest level manufacturing code associated with a particular component is typically referred to as the “low-level code” for that component. For example, FIG. 2 shows low-level codes related to the manufacturing level codes discussed above in reference to FIG. 1. The low-level codes 200 show that product A has a low-level code 0. Product B has a low-level code 1. These low-level codes are consistent with the manufacturing codes 100. However, product C, because it is also needed one level deeper, i.e. in manufacturing level 2, has a low-level code 2, instead of 1. Product D also has the deepest low-level code 2. This particular example illustrates how the low-level codes relate to the sequence of manufacturing processes depicted in the manufacturing level codes.

Accordingly, preference determination for single source products can easily be determined from the low-level codes of the associated BOM. However, complications arise when products are produced by multiple manufacturers, or include components that are manufactured by multiple manufacturers. Because the manufacturing processes of each of manufacturers are different, their manufacturing level codes for each product or component are most likely also different. Accordingly, a determination of the low-level-codes from the disparate manufacturing codes in the BOMs received from the various manufacturers often produces conflicting or incompatible low-level codes.

For example, one manufacturer may produce products D and C in manufacturing level 5, while another manufacturer may produce product D in manufacturing level 5, but produce product C in manufacturing level 4. The low-level codes for products D and C will be different based on the manufacturing codes listed in the respective BOMs, e.g., the low-level codes for products D and C will be 5 from one manufacturer, while the low-level codes for products D and C will be 5 and 4, respectively, from the other manufacturer. The disparity in the low-level codes from the various manufacturers in mixed origin products can complicate the preference determination or produce erroneous results that are not compliant with the requirements for preferential customs duty.

FIG. 3 illustrates the complexity of performing a reliable preference determination for a product A with BOMs originating from multiple manufacturers. The central office system 320, such as that associated with a final assembly manufacturer, can receive multiple BOMs from the feeder systems/manufacturing plants 315 for the variants of product A or the various components of product A. The BOMs from the various manufacturing plants 315 can include low-level codes for the variants of product A and components B, C, and D. The low-level code for product A in BOM 317-1 from manufacturing plant 315-1 is 0. The low-level code for component B in BOM 317-2 from manufacturing plants 315-2 is 1. The low-level code for product A in BOM 317-3 from the manufacturing plant 315-3 is 2. The low-level code for component B in BOM 317-N from manufacturer 315-N is M. Accordingly, when each of the low-level codes for the BOMs 317 are transferred to the central office system 320, it is difficult to determine which low-level codes for product A and components B, C, and D will be used for a preference determination for product A. To obtain a reliable preference determination result for customs duties, the various low-level codes each of the feeder manufacturing plants need to be harmonized. Various embodiments of the present disclosure address this and other issues.

### SUMMARY

Embodiments of the present disclosure improve low-level code harmonization for BOMs received from multiple manufacturing sources. In one embodiment of the present invention includes a method that includes receiving a plurality of bills of materials (BOMs), wherein the plurality of BOMs are associated with a plurality of corresponding products and a plurality of corresponding low-level codes and wherein the low-level codes classify the plurality of products according to a plurality of manufacturing levels. The method also include sorting the BOMs according to the plurality of corresponding low-level codes into an order, scanning through the plurality of corresponding low-level codes incrementally in the order to determine a first portion of the plurality of BOMs associated with a first product in the plurality of products, determining a first portion of the plurality of corresponding low-level codes associated with the first portion of the plurality of BOMs, determining a lowest low-level code in the first portion of the plurality of corresponding low-level codes, and associating the lowest low-level code in the first portion of the plurality of corresponding low-level codes with each of the first portion of the plurality of BOMs.

One embodiment of the present disclosure includes scanning through the plurality of corresponding low-level codes incrementally in the order to determine a second portion of the plurality of BOMs associated with second product in the plurality of products, determining a second portion of the plurality of corresponding low-level codes associated with the second portion of the plurality of BOMs, determining a lowest low-level code in the second portion of the plurality of corresponding low-level codes, and associating the lowest low-level code in the second portion of the plurality of corresponding low-level codes with each of the second portion of the plurality of BOMs.

One embodiment of the present disclosure includes scanning through the plurality of corresponding low-level codes incrementally in the order to determine a second portion of the plurality of BOMs having the first product in the plurality of products as a component, determining a second portion of the plurality of corresponding low-level codes associated with the second portion of the plurality of BOMs, determining, in the computer system, a lowest low-level code in the second portion of the plurality of corresponding low-level codes, and associating the lowest low-level code in the second portion of the plurality of corresponding low-level codes with each of the first portion of the plurality of BOMs.

In one embodiment of the present disclosure the order ascends from a low manufacturing level value to a high manufacturing level value.

In one embodiment of the present disclosure the lowest low-level code in the first portion of the plurality of corresponding low-level codes is used for determination of preferential customs duty for the first product or another product in the plurality of products.

In one embodiment of the present disclosure the plurality of BOMs are received from a plurality of different sources, and wherein the plurality of manufacturing levels differ from one another according to the different sources.

In one embodiment of the present disclosure at least one of the plurality of BOMS associated with a first corresponding product in the plurality of corresponding products comprises a second corresponding product in the plurality of corresponding products as a component

Another embodiment of the present invention includes a non-transitory computer-readable storage medium containing instructions that, when executed, control a computer processor to be configured for: receiving a plurality of bills of materials (BOMs), wherein the plurality of BOMs are associated with a plurality of corresponding products and a plurality of corresponding low-level codes, wherein the low-level codes classify the plurality of products according to a plurality of manufacturing levels, sorting the BOMs according to the plurality of corresponding low-level codes into an order, scanning through the plurality of corresponding low-level codes incrementally in the order to determine a first portion of the plurality of BOMs associated with a first product in the plurality of products, determining a first portion of the plurality of corresponding low-level codes associated with the first portion of the plurality of BOMs, determining a lowest low-level code in the first portion of the plurality of corresponding low-level codes, and associating the lowest low-level code in the first portion of the plurality of corresponding low-level codes with each of the first portion of the plurality of BOMs.

Another embodiment of the present invention includes a system comprising: one or more computer processors; and a non-transitory computer-readable storage medium containing instructions, that when executed, control the one or more computer processors to be configured for: receiving a plurality of bills of materials (BOMs), wherein the plurality of BOMs are associated with a plurality of corresponding products and a plurality of corresponding low-level codes; wherein the low-level codes classify the plurality of products according to a plurality of manufacturing levels, sorting the BOMs according to the plurality of corresponding low-level codes into an order, scanning through the plurality of corresponding low-level codes incrementally in the order to determine a first portion of the plurality of BOMs associated with a first product in the plurality of products, determining a first portion of the plurality of corresponding low-level codes associated with the first portion of the plurality of BOMs, determining a lowest low-level code in the first portion of the plurality of corresponding low-level codes, and associating the lowest low-level code in the first portion of the plurality of corresponding low-level codes with each of the first portion of the plurality of BOMs.

The following detailed description and accompanying drawings provide a better understanding of the nature and advantages of the present invention.

### BRIEF DESCRIPTION OF THE DRAWINGS

FIG. 1 illustrates an example of manufacturing codes for a particular set of related products.

FIG. 2 illustrates an example of low-level codes for a particular set of related products.

FIG. 3 illustrates the complexity of determining low-level codes for mixed origin BOMs for a particular set of products.

FIG. 4 illustrates a system for determining low-level codes for mixed origin BOMs, according to one embodiment of the present disclosure.

FIGS. 5-16 illustrates a top-down low-level code harmonization process for multiple BOMs, according to one embodiment of the present disclosure.

FIG. 17 is a flowchart for top-down low-level code harmonization method for multiple BOMs, according to one embodiment of the present disclosure.

FIG. 18 is a flowchart for top-down low-level code harmonization method for multiple BOMs, according to one embodiment of the present disclosure.

FIG. 19 illustrates an example computer system and networks that can be used to implement embodiments of the present disclosure.

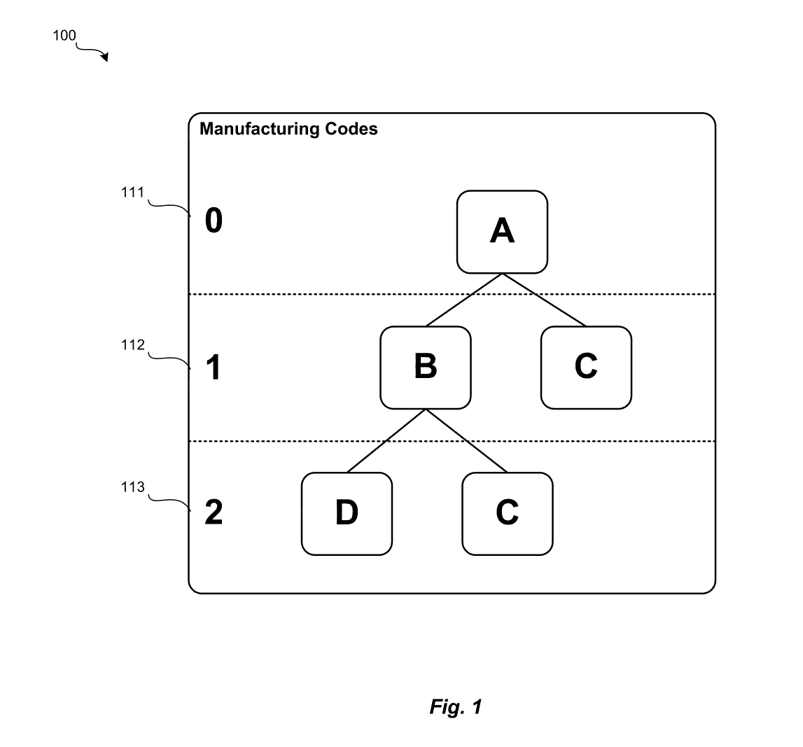

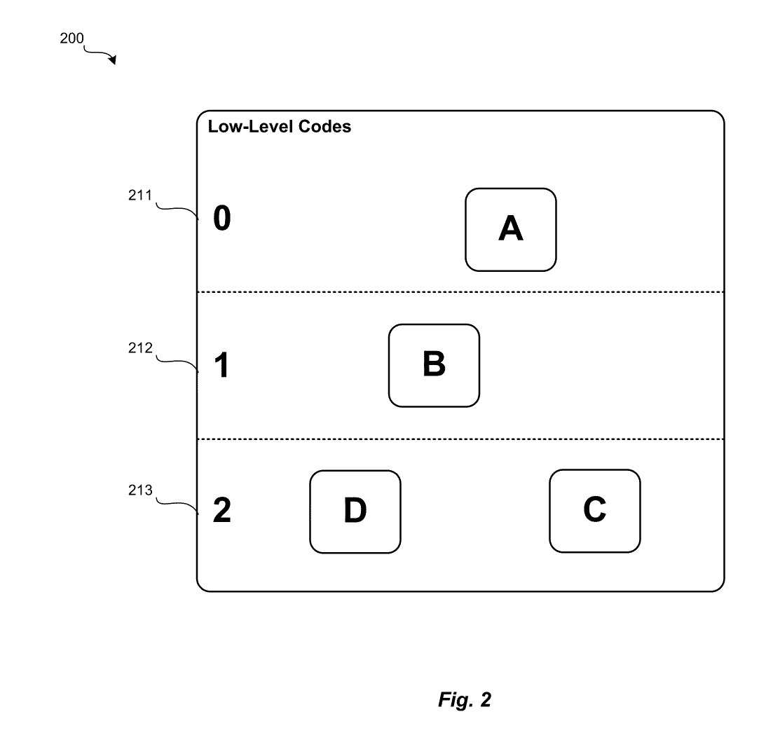

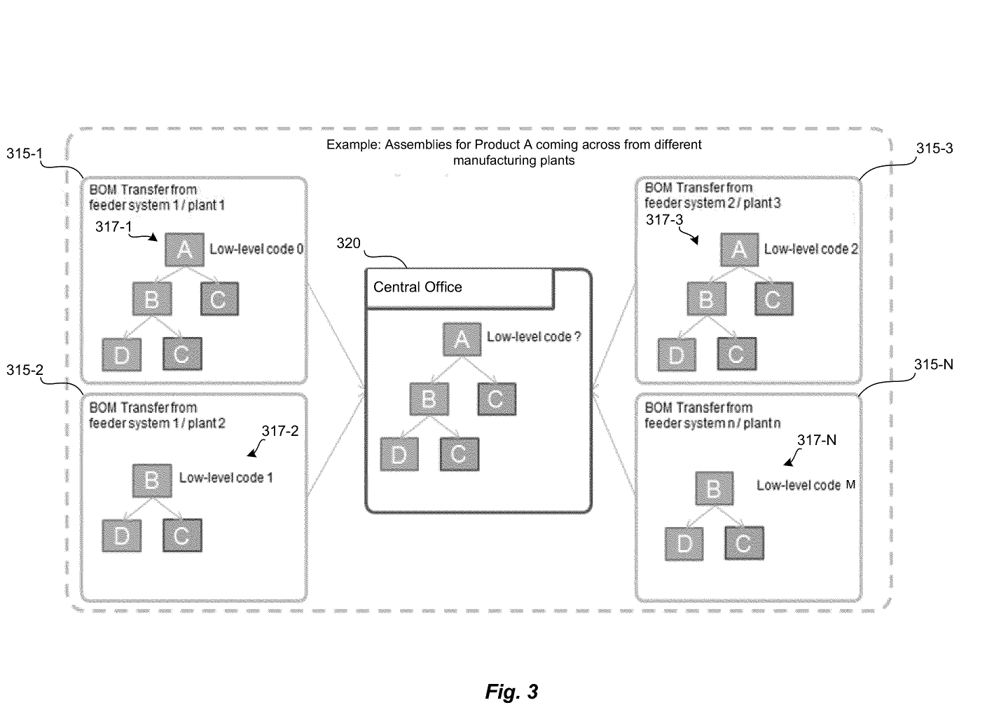

### DETAILED DESCRIPTION

Described herein are techniques for systems and methods for low-level code harmonization among BOMs from multiple manufacturers. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

Embodiments of the present disclosure include a systematic top-down technique for analyzing and harmonizing the low-level codes in BOMs that include mixed origin products and components. The techniques include systems and methods that can receive multiple BOMs from multiple manufacturing plants. Because of the differences in the manufacturing processing, the low-level codes associated with each BOM and each component of a BOM can vary. In some embodiments, the BOMs are first sorted according to the low-level code associated with the end products and ranked by low-level code. The ranked BOMs are then scanned in ascending order, e.g., from highest low-level code to lowest low-level code. The low-level code of any BOMs for an identical or similarly identified product can be associated with the lowest low-level code associated with a BOM for that product. This process is repeated for all products with BOMs in the multiple BOMs. Once all of the end-product BOMs for the particular end products are harmonized, the method can continue to scan through the low-level codes. For each BOM for a product at a given level, embodiments of the present invention also check for BOMs in which the product is included as a component for the associated low-level codes. If another BOM includes the product as a component and the low-level code of the product as a component is lower, then the BOMs for the product are associated with the lower low-level codes. This process is repeated for products as the low-level codes are scanned in ascending order, and results in consistently compliant low-level codes for preference determinations.

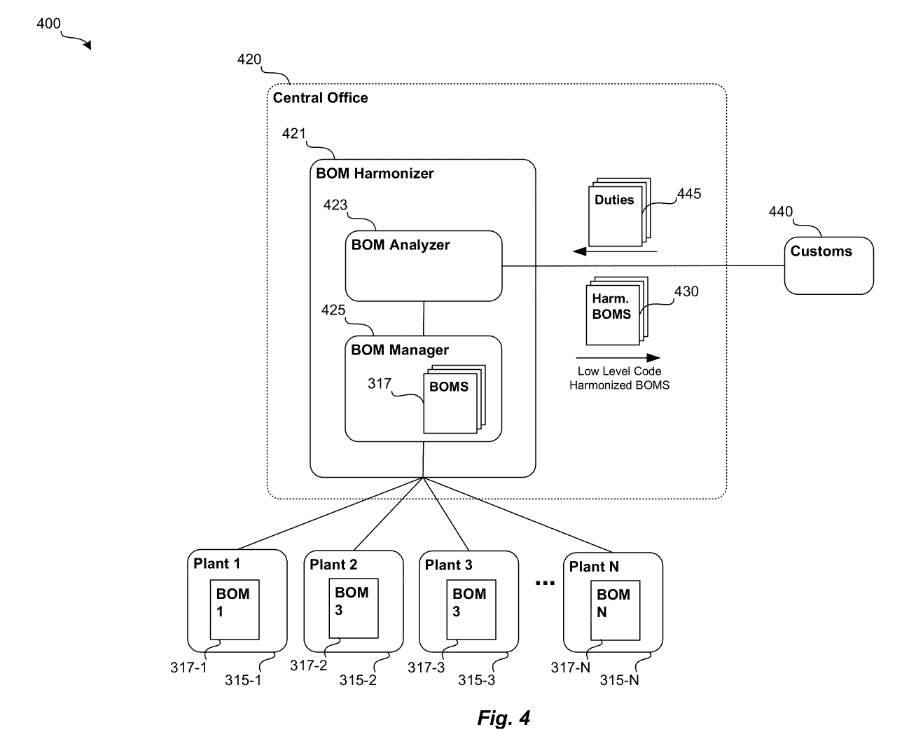

FIG. 4 illustrates a system 400 for determining harmonized low-level codes from BOMs 317 from multiple manufacturing plants 315. As shown, system 400 can include a central office system 420 in communication with multiple manufacturing plants 315. The manufacturing plants 315 can manufacture various products and components that a manufacturer associated with the central office system 420 can use for in-house assembly of various components and end products. The manufacturing plants 315 can send the respective BOMs 317 to BOM harmonizer 421. The BOM harmonizer 421 can include a BOM analyzer 423 and a BOM manager 425. The BOM manager 425 can receive the multiple BOMs 317 from each one of the respective manufacturing plants 317. The BOM analyzer 423 can systematically analyze the low-level codes listed in each of the BOMs 317 to determine a harmonized set of low-level codes for each product and component listed in the BOMs 317. The low-level code harmonized BOMs 430 can then be sent to one or more external entities for various data analysis, such as to customs 440 for preferential customs duty analysis. In response, the customs offices 440 can return a listing of applicable duties 445 to the central office system 420. In other embodiments, the central office system 420 can also perform its own preference determination for internal planning regarding preferential customs duty of particular components and products listed in the BOMs 317.

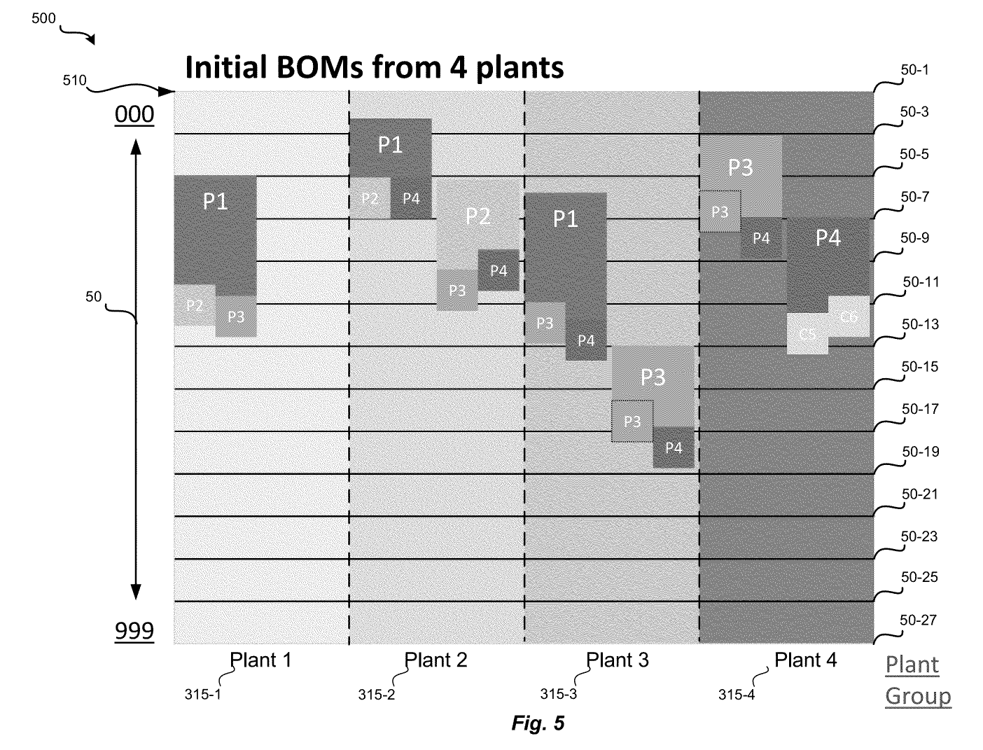

The specific analysis and methods used by the BOM harmonizer 421, and the BOM analyzer 423, will now be discussed in more detail. Various embodiments of the present disclosure include ranking the BOMs from individual manufacturing plants according to the low-level codes included in the BOMs and then adjusting the low-level code for each product or component in the BOMs according to the ranked order. FIGS. 5 through 16 illustrate the steps and analysis of a top-down horizontal ranking and vertical insertion method 500 according to various embodiments of the present disclosure.

FIG. 5 illustrates the low-level code rankings of the products and components P1, P2, P3, P4, C5, and C6 according to the low-level codes included in the BOMs from four different manufacturing plants 315. Each of the products and components are ranked according to their respective low-level codes on scale 50. In this particular example, scale 50 can range from 000 to 999. Manufacturing plant 1, shown at 315-1, manufactures product P1 made of products P2 and P3. Manufacturing plant 2, shown at 315-2, manufacturers product P1 and P2. Product P1 from manufacturing plant 2 is manufactured from products P2 and P4. Product P2 from manufacturing plant 2 is manufactured from product P3 and product P4. Manufacturing plant 3, shown at 315-3, manufacturers product P1 and product P3. Product P1 from manufacturing plant 3 is manufactured from product P3 and product P4. Product P3 from the manufacturing plant 3 is manufactured from product P3 and product P4. Finally, manufacturing plant 4, shown at 315-4, manufactures product P3 and product P4. Product P3 is manufactured from another version of product P3 and product P4. Product P4 is manufactured from components C5 and C6. As shown, each of products P1, P2, P3, and P4 all have disparate low-level codes in the corresponding BOMs depending on the originating manufacturing plants 315.

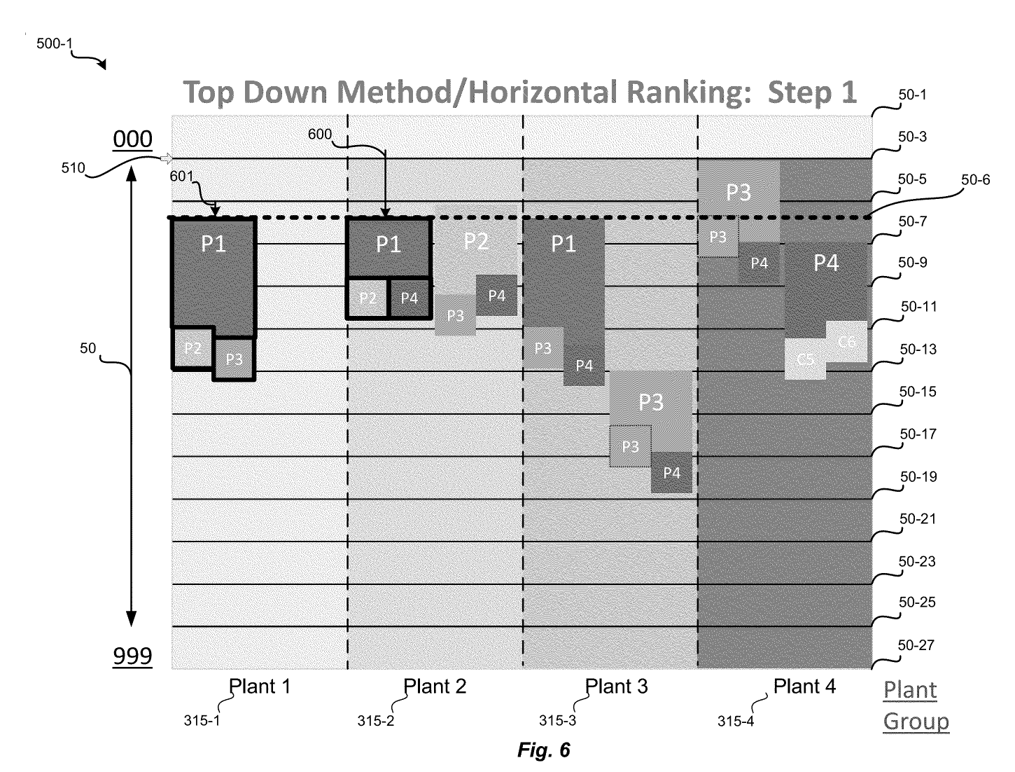

FIG. 6 illustrates the first step of the top-down method for harmonizing the low-level codes for BOMs of the various products P1, P2, P3, and P4. In the first step of the method 500, each of the BOMs are sorted and ranked according to low-level codes of the end product and the constituent components, i.e., the products that are delivered from each one of the manufacturing plants 315. In the particular example shown, end products include product P1, P2, P3 and P4. The top-down aspect of the method 500 includes moving pointer 510 down along scale 50 from position 50-1 towards 50-27, thus scanning all possible low-level codes.

In the first step, pointer 510 moves from position 50-1 to 50-3, scanning all intermediate low-level codes until is observes a BOM with a particular low-level code. In this particular example, when pointer 510 moves from position 50-1 to 50-3, the BOM harmonizer can determine that product P1 from manufacturing plant 2 has the highest low-level code among the low-level codes for all of the BOMs for product P1. Thus the BOM harmonizer can change the low-level code from the original low-level code between 50-1 and 50-3 to 50-6, in change 600. Similarly, the BOM harmonizer can also determine that the low-level code of product P1 in the BOM from manufacturing plant 1 is also higher than the low-level code of product P1 in the BOM from manufacturing plant 3 and change the low-level code from 50-5 to 50-6 in change 601. Accordingly, all the BOMs for product P1 are all now set to the low-level code at 50-6.

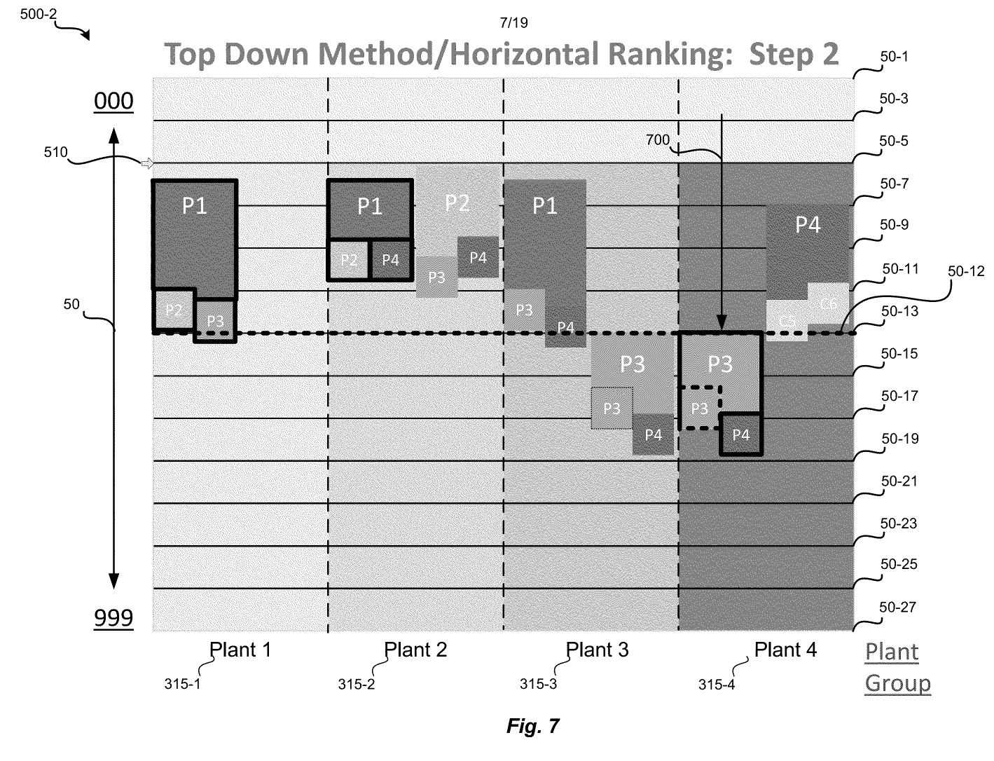

FIG. 7 shows the next step of method 500 for horizontally ranking the BOMs according to low-level codes. In moving the pointer from 50-3 to 50-5, the BOM harmonizer can determine that the low-level code of the BOM for product P3 from manufacturing plant 4 is higher than the low-level code of the BOM for product P3 from manufacturing plant 3. In response, the BOM harmonizer can change the low-level code associated with the BOM of product P3 from manufacturing plant 4 from between 50-1 and 50-3 to 50-12, in change 700. After change 700, the low-level codes of the BOMs associated with each of the end products from each of the manufacturing plants 315 are now harmonized. Accordingly, the BOMs for product P1 from manufacturing plants 1, 2, and 3 all have the same low-level code. The low-level code for the BOMs for products P2 and P4 are unchanged since those end products are only manufactured by manufacturing plants 2 and 4, respectively. However, the BOMs for product P3 from manufacturing plants 3 and 4 now have the same low-level code.

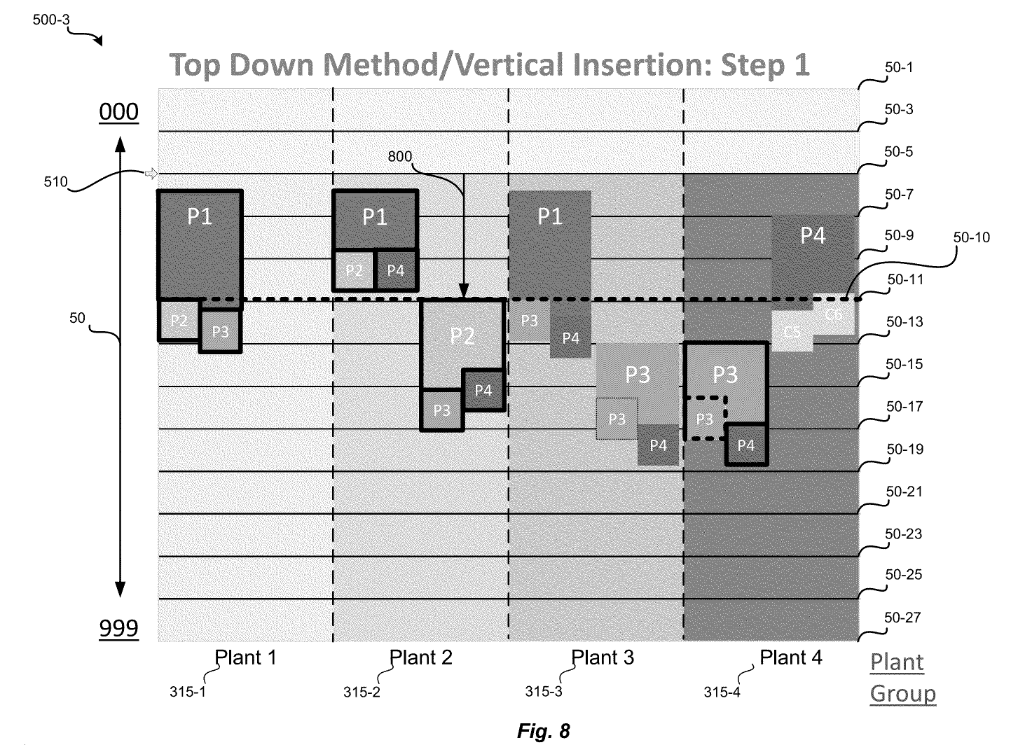

FIG. 8 illustrates the first step in the vertical insertion portion of the top-down method 500 of low-level code harmonization, according to various embodiments of the present disclosure. During the vertical insertion portion, the low-level code of the BOMs for each end product is changed to the lowest low-level code associated with that end product across all BOMs. Accordingly, when pointer 510 is at level 50-5, the BOM harmonizer can determine that the lowest low-level code for product P2 occurs in the BOM for P1 from manufacturing plant 1. This illustrates how P2 is required before manufacturing of P1 can begin in manufacturing plant 1. Accordingly, the low-level code of the BOM for P2 from manufacturing plant 2 is changed from 50-5 to 50-10, in change 800.

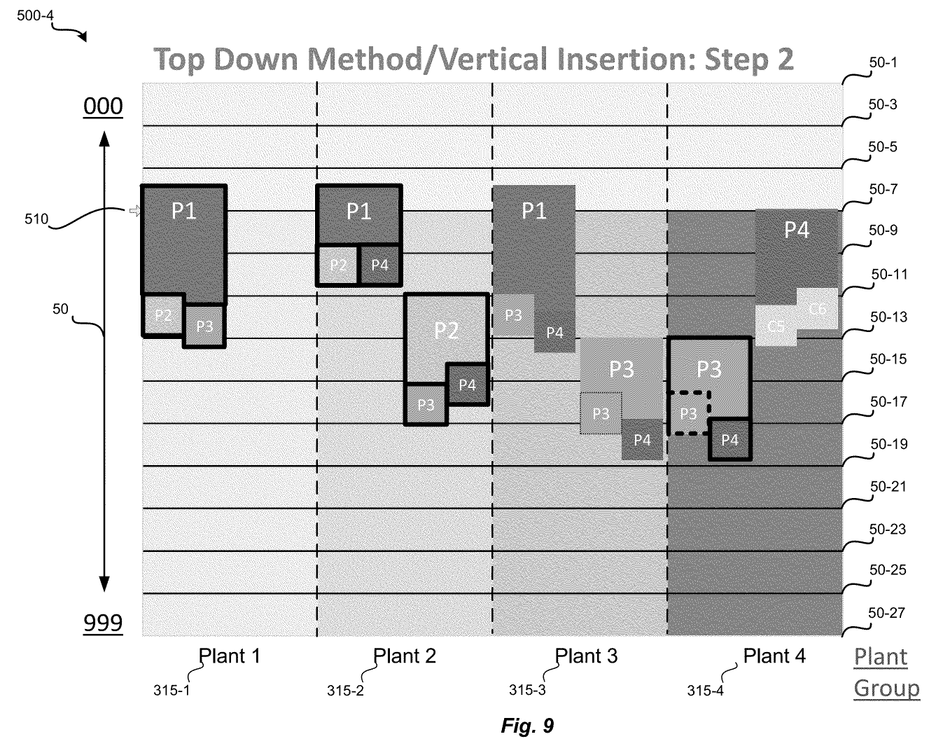

FIG. 9 illustrates the next step of method 500, in which pointer 510 moves from 50-5 to 50-7. In moving from level 50-5 to 50-7, the BOM harmonizer can determine that the low-level codes for P1 are already harmonized, and makes no changes to the corresponding low-level codes.

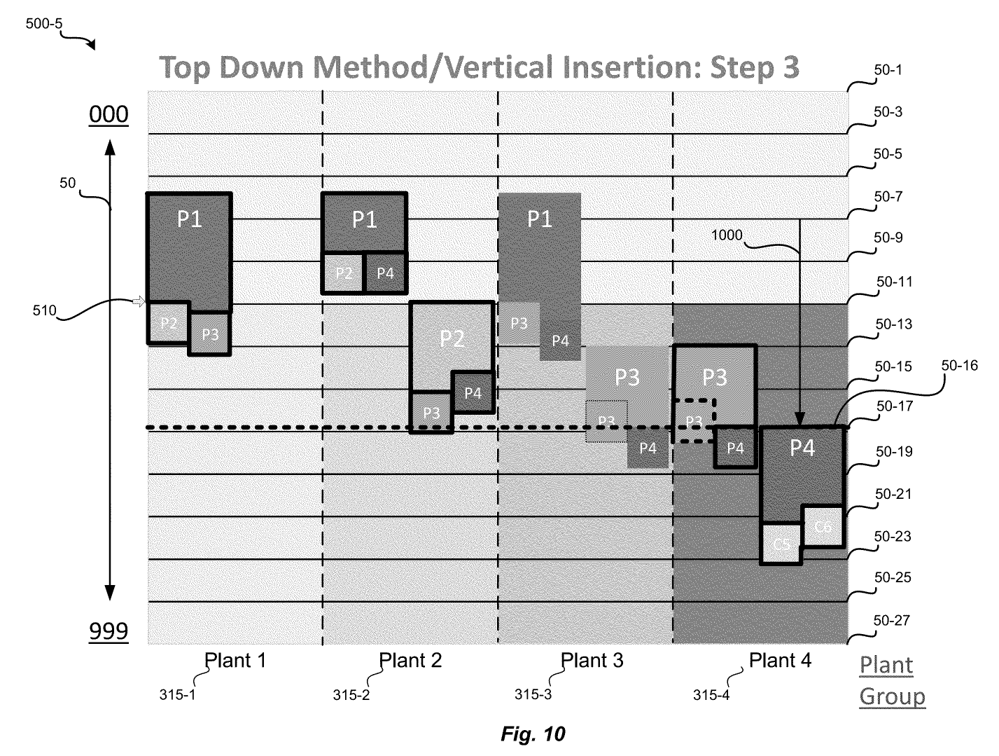

FIG. 10 further illustrates the progression of the analysis of the method 500, in which pointer 510 moves from 50-7 down to 50-11, during which the BOM harmonizer can determine that the low-level code of the BOM for end product P4 from manufacturing plant 4 is higher than the lowest low-level code for P4 as a component in the BOMs for product P3 from manufacturing plants 3 and 4. Accordingly, the BOM harmonizer can change the low-level code of the BOM for end product P4 from 50-7 to 50-16 to match the low-level codes of product P4 in the BOMs from manufacturing plant 3 and 4, in which product P4 is used a component. Accordingly, change 1000 of the low-level code to level 50-16 indicates that product P4 must be manufactured and ready before product P3 from manufacturing plants 3 and 4 can be manufactured.

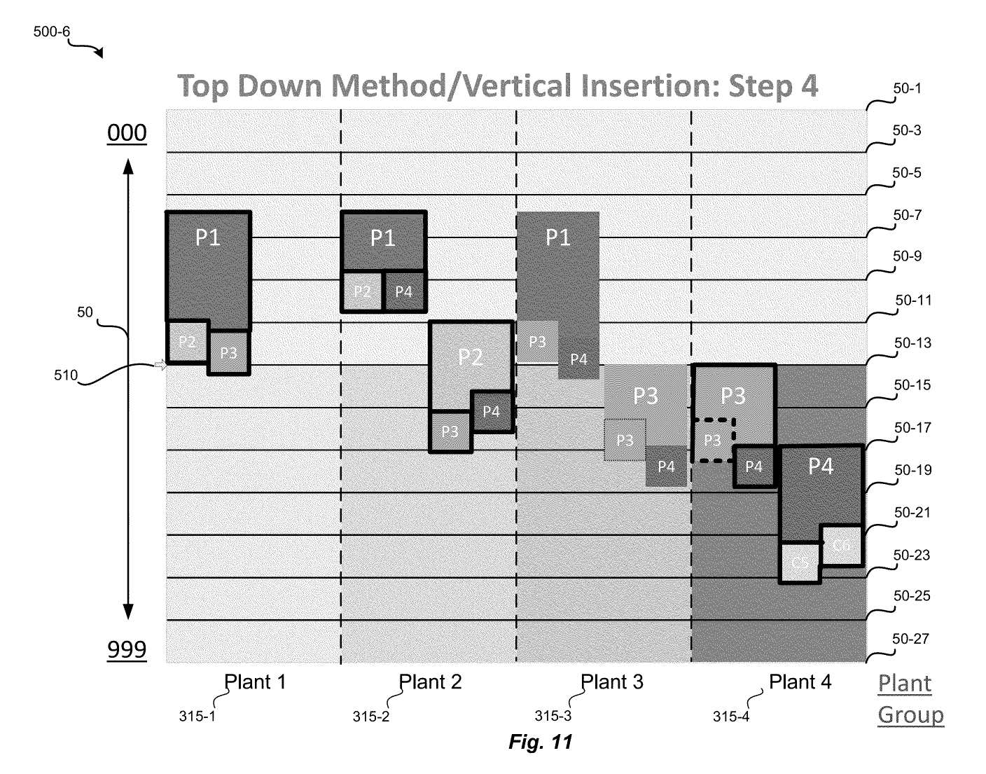

FIG. 11 illustrates the next step in the progression of method 500, in which pointer 510 moves from 50-11 to 50-13. In moving from level 50-11 to 50-13, the BOM harmonizer can determine the low-level codes of the BOM for product P2 are already harmonized for all BOMs from all manufacturers 315, and makes no changes.

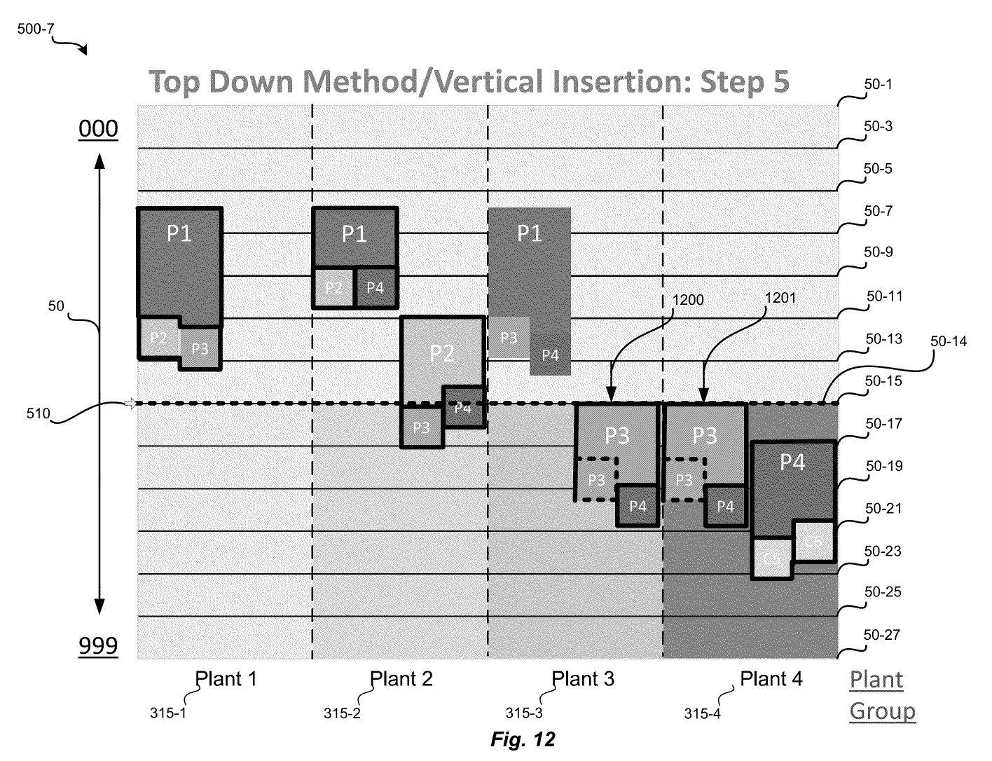

FIG. 12 illustrates moving pointer 510 from level 50-13 to 50-15. In moving from 50-13 to 50-15, the BOM harmonizer can determine that the low-level codes of the BOM for product P3 from manufacturing plants 3 and 4 are higher than the lowest low-level code assigned to product P3 in a BOM in which product P3 is listed as a component. Accordingly, BOM harmonizer can shift the low-level codes associated with the BOM for product P3 from manufacturers 3 and 4 to level 50-14 to match the low-level code of P3 in the BOM for P2 from manufacturing plant 2, in changes 1200 and 1201.

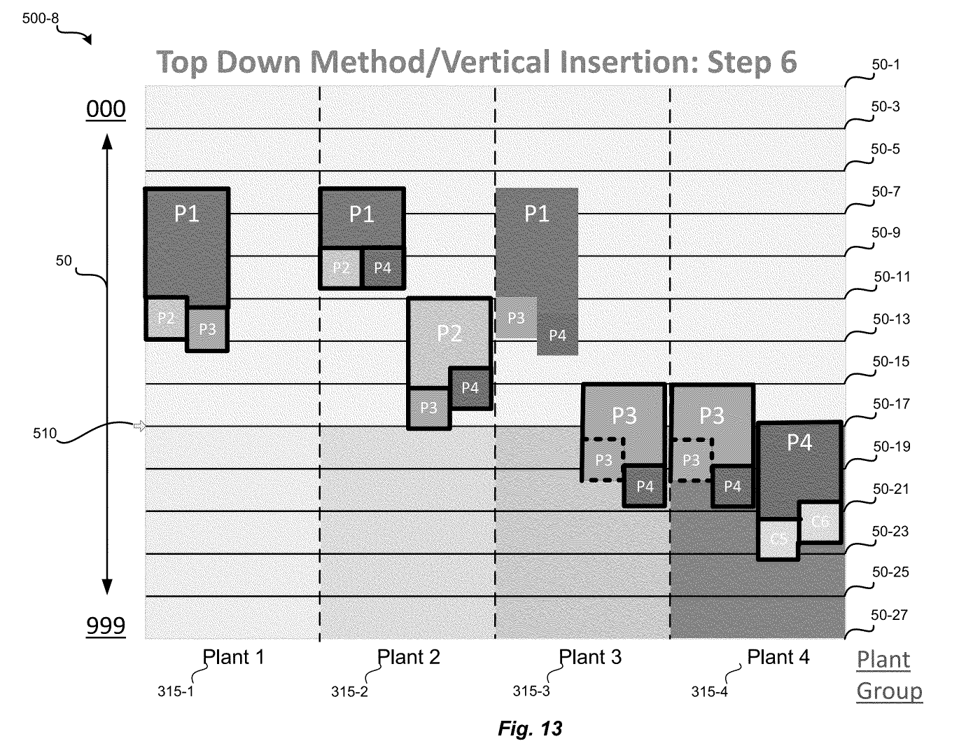

FIG. 13 illustrates another step of method 500, in which pointer 510 moves from level 50-15 to 50-17. In moving from level 50-15 to 50-17, the BOM harmonizer can determine that the low-level codes of the BOM for product P3 are already harmonized for all BOMs from all manufacturers 315 at 50-17, and makes no changes.

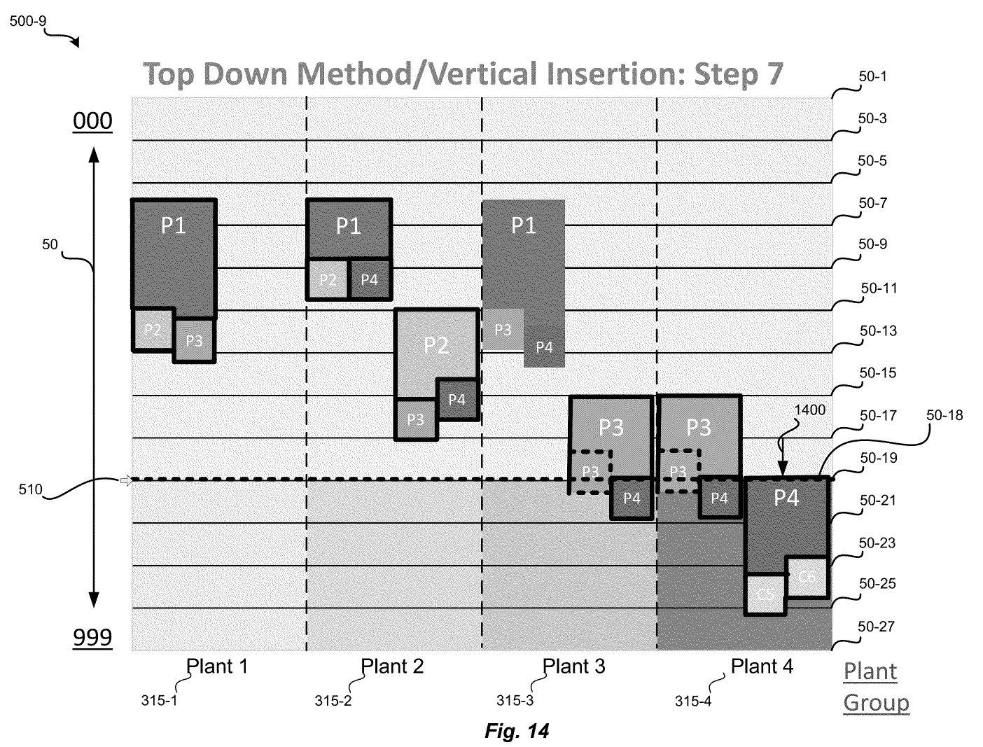

In FIG. 14, pointer 510 moves from level 50-17 to 50-19. In doing so, the BOM harmonizer can determine that because the low-level codes of the BOM for product P3 from manufacturing plants 3 and 4 shifted down in actions 1200 and 1201, the lowest low-level code in the BOM for P3 from manufacturing plants 3 and 4 also shifted. Accordingly, the low-level code for end product P4 is now higher than the lowest low-level code for P4 in BOMs in which product P4 is listed as a component. To harmonize the BOMs, the BOM harmonizer can change the low-level code of the BOM for P4 from manufacturing plant 4 from level 50-17 to 50-18, in change 1400.

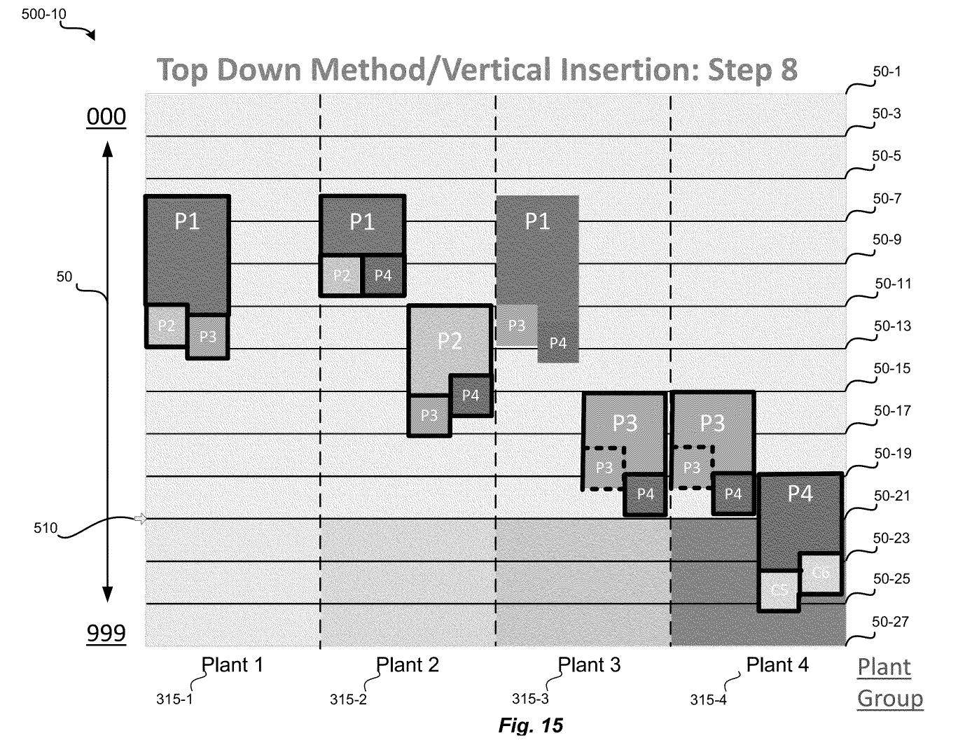

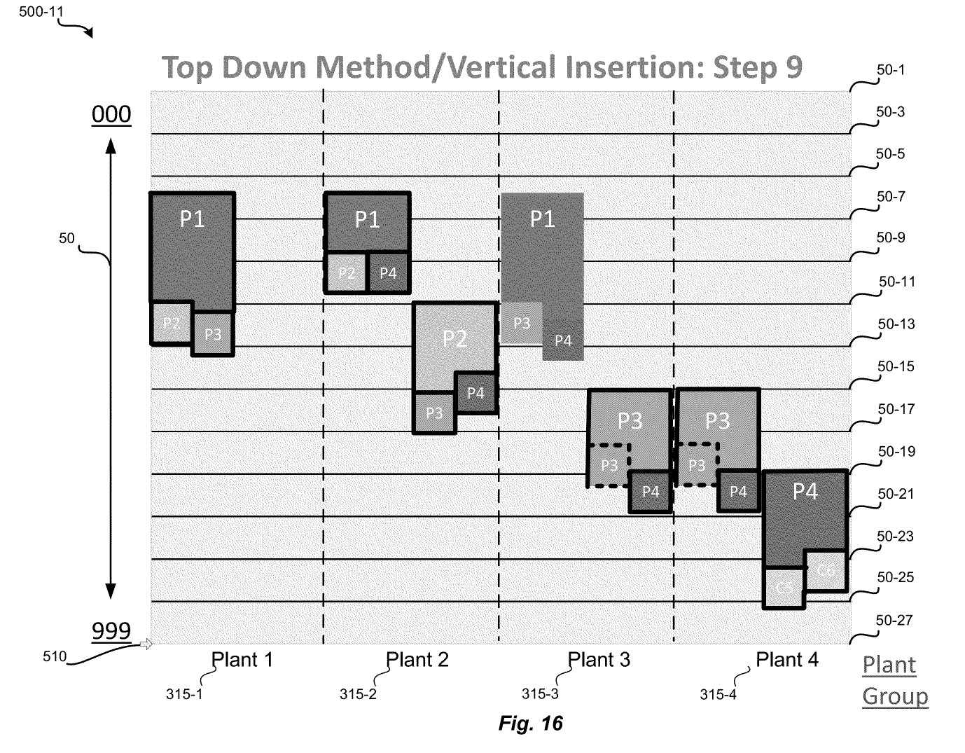

FIGS. 15 and 16 illustrate the next sequential steps in the top-down method 500 in which the pointer 510 moves from level 50-21 to 50-27. In the scan from level 50-21 to 50-27, the BOM harmonizer can determine that components C5 and C6 are at the lowest low-level code across all BOMs from all manufacturers 315. As such, the low-level codes for all of the products P1, P2, P3, and P4, and components C5 and C6 are now harmonized across all BOMs. The harmonized low-level codes in the BOMs can now be used for various purposes, such as making a preference determination.

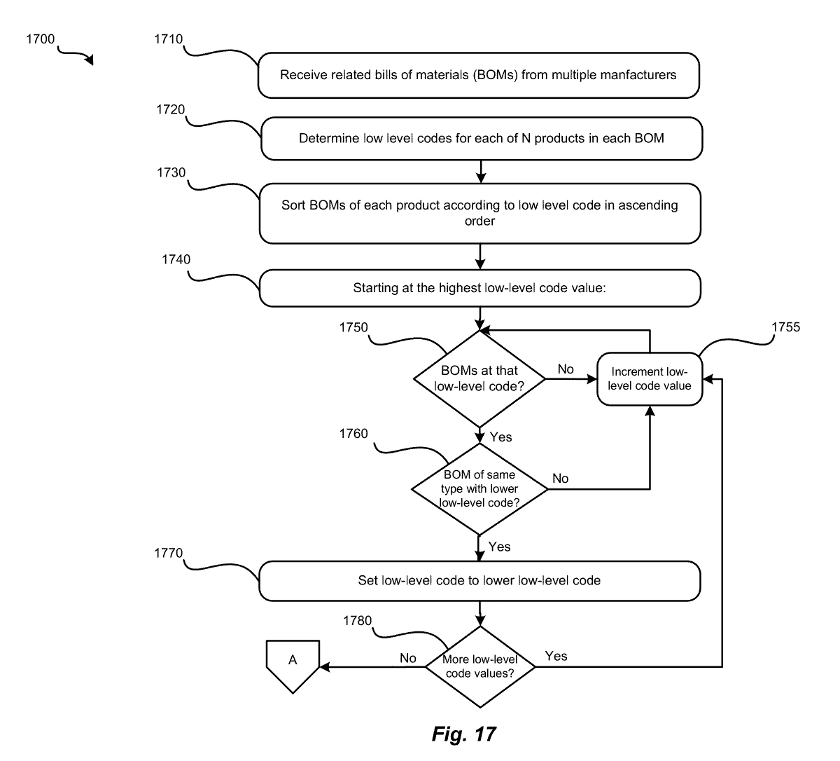

FIG. 17 depicts a flowchart of method 1700 for harmonizing the low-level codes of BOMs for multiple products received from multiple manufacturing plants. The method 1700 can begin at action 1710 in which a BOM harmonizer, associated with a central or final assembly manufacturer, receives BOMs for various related products from multiple manufacturing plants. The BOMs can each be of a particular type. That means, each BOM can be related to a particular product; and in some instances, any particular product can be used as a constituent component in the BOM of another product. The central or final assembly manufacturer can use the various products to manufacture one or more other final products. As such, the BOMs can be related to one another according to the product and constituent components of the product included in each of the BOMs.

In action 1720, the BOM harmonizer can determine the low-level codes for each BOM. In some embodiments, determining the low-level codes for each of the BOMs can include examining the manufacturing codes associated with each of the BOMs and the constituent components. The low-level code for each type of BOM, e.g., the BOM for a particular product or component, can include the lowest level manufacturing code in which the associated product occurs in the manufacturing process associated with a particular manufacturing plant. In some embodiments, the higher the value of the manufacturing code, the lower the low-level code, i.e., higher manufacturing code values indicate lower low-level codes. Determining the low-level codes for each BOM can include assigning or determining a low-level code for each product and component in the BOM.

In action 1730, the BOM harmonizer can sort the BOMs according to the low-level codes. In some embodiments, the BOMs are sorted in ascending order from highest low-level code to the lowest low-level code. In other embodiments, the BOMs are sorted in descending order from lowest low-level code to the highest low-level code. As discussed herein, low numerical values for low-level codes indicate a higher low-level code, while higher numerical values for low-level codes indicate a lower low-level code. Accordingly, for BOMs, products, and components discussed herein, low-level codes values closer to 0 are higher low-level codes than low-level codes closer to 999.

In action 1740, the BOM harmonizer can start at the highest low-level code, i.e. low-level code 0. In other embodiments, the BOM harmonizer can start at the highest low-level code associated with the set the received BOMs. In some instances, at least one of the received BOMs has a low-level code 0. Accordingly, the BOM harmonizer will begin at low-level code 0. The highest low-level code of the BOMs received from the multiple manufacturers might be greater than 0, accordingly, action 1740 can begin at that low-level code. In all of such instances, the BOM harmonizer can determine if any of the received BOMs are associated with the highest low-level code. If there are no BOMs at the highest low-level code, then the BOM harmonizer can increment the low-level code value in action 1755. The BOM harmonizer can then repeat the check at each incremental low-level code until it determines that one or more of the BOMs in the received BOMs is associated or includes the incremented low-level code. In this way, the BOM harmonizer can perform a top-down scan, e.g., 000 to 999, through all possible low-level codes.

When the BOM harmonizer, at determination 1750, determines a BOM of a particular type, e.g., a BOM for a particular product at the incremented low-level code, the BOM harmonizer can check whether another BOM of the same particular type exists within the set of received BOMs that has a lower low-level code at action 1760. If there are no BOMs of the same particular type with a lower low-level code, then the BOM harmonizer can increment the low-level code value again at action 1755. However, if the BOM harmonizer determines that there is another BOM of the same particular type with a lower low-level code, then the BOM harmonizer can set the low-level code for all of the BOMs of that particular type to the lowest low-level code determined.

Once the BOM harmonizer has adjusted the low-level codes of the BOMs for the particular type, it can determine whether or not there are more low-level codes to check, in determination 1780. If there are more low-level codes to check, then the BOM harmonizer can increment the low-level code in action 1755 and repeat determinations 1750, 1760, and action 1770, for the remainder of the low-level codes. However, if the BOM manager determines that there are no more low-level codes to scan, e.g., the BOM harmonizer has reached the lowest low-level code possible, the method 1700 can begin the next phase of the method.

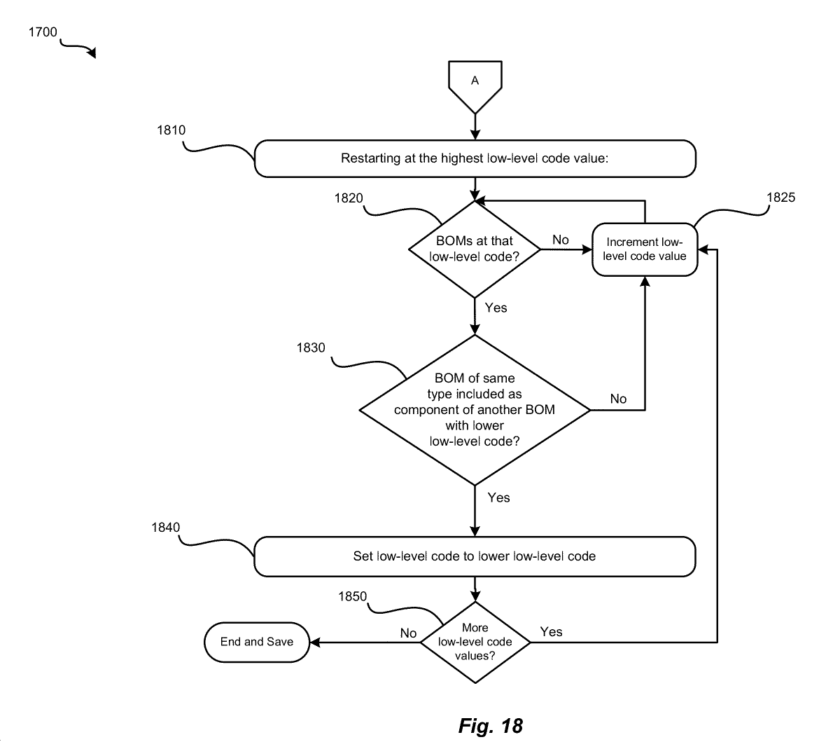

FIG. 18 depicts a flowchart for the continuation of method 1700. In action 1810, the BOM harmonizer can restart at the highest low-level code to reinitiate the scan from the highest low-level code to the lowest low-level code. For each low-level code, the BOM harmonizer can check if there are any BOMs that have that low-level code. If there are no BOMs at that particular low-level code, then the BOM harmonizer can increment the low-level code value in action 1825. If the BOM harmonizer determines that there is a BOM of a particular type, e.g. product, with the particular incremented low-level code, then the BOM harmonizer can check the other received BOMs for components of the same particular type with lower low-level codes. For example, the BOM harmonizer can check all of the received BOMs for instances of the particular product and compare the low-level code of any observed instances of the particular product with the incremented low-level code. If the product exists in another BOM as a component of another product, and has a lower low-level code, then the BOM harmonizer can set the low-level code for the observed BOM at the incremented low-level code to the lower low-level code, in action 1840.

If there are more low-level codes to check, and then BOM harmonizer can increment the low-level code value, in action 1825, and repeat determinations 1820 and 1830, and action 1840 until all of the low-level codes have been checked. Once all the low-level codes have been checked, then the BOM harmonizer can end the process and save all of the harmonized low-level codes for each of the BOMs. The harmonized low-level codes for each of the BOMs can then be used for various other processes, such as preferential determination.

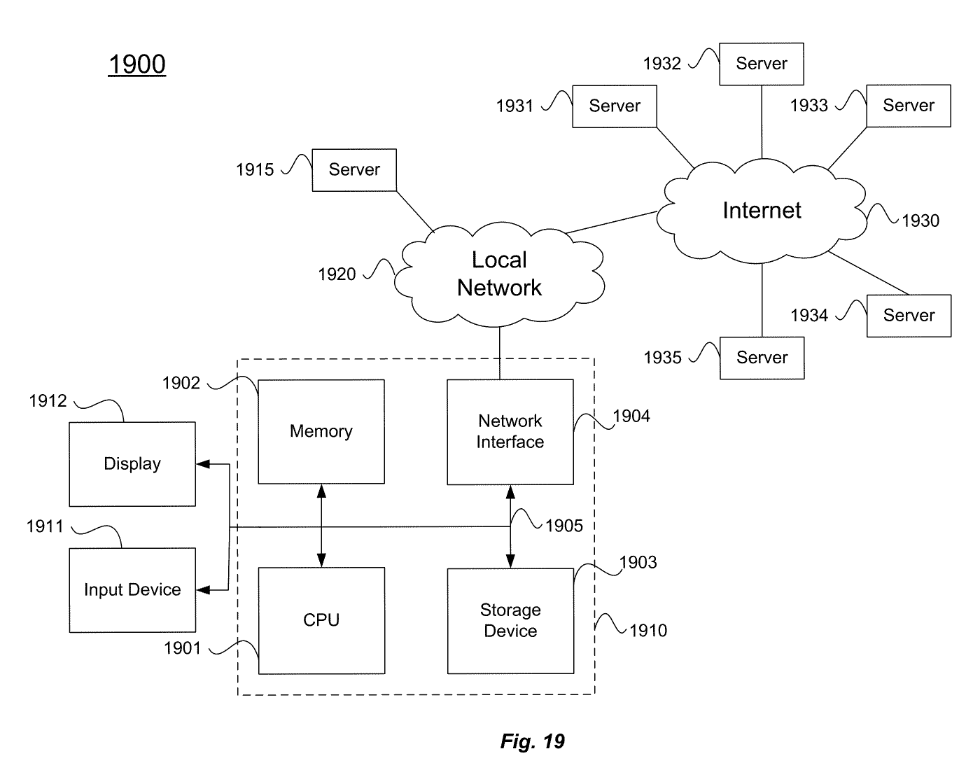

FIG. 19 illustrates an example computer system and networks that may be used to implement one embodiment of the present invention. Computer system 1910 includes a bus 1905 or other communication mechanism for communicating information, and a processor 1901 coupled with bus 1905 for processing information. Computer system 1910 also includes a memory 1902 coupled to bus 1905 for storing information and instructions to be executed by processor 1901, including instructions for performing the techniques described above. This memory may also be used for storing temporary variables or other intermediate information during execution of instructions to be executed by processor 1901. Possible implementations of this memory may be, but are not limited to, random access memory (RAM), read only memory (ROM), or both. A storage device 1903 is also provided for storing information and instructions. The information instructions can be in the form of computer readable code stored on the storage device, accessible and executable by processor to implement various techniques and methods of the present disclosure. Common forms of storage devices include non-transient, non-volatile computer readable media, for example, a hard drive, a magnetic disk, an optical disk, a CD, a DVD, a flash memory, a USB memory card, or any other medium from which a computer can read.

Computer system 1910 may be coupled via the same or different information bus, such as bus 1905, to a display 1912, such as a cathode ray tube (CRT) or liquid crystal display (LCD), for displaying information. An input device 1911 such as a keyboard and/or mouse is coupled to a bus for communicating information and command selections from the user to processor 1901. The combination of these components allows the user to communicate with the system.

Computer system 1910 also includes a network interface 1904 coupled with bus 1905. Network interface 1904 may provide two-way data communication between computer system 1910 and the local network 1920. The network interface 1904 may be a digital subscriber line (DSL) or a modem to provide data communication connection over a telephone line, for example. Another example of the network interface is a local area network (LAN) card to provide a data communication connection to a compatible LAN. Wireless links is also another example. In any such implementation, network interface 1904 sends and receives electrical, electromagnetic, or optical signals that carry digital data streams representing various types of information.

Computer system 1910 can send and receive information, including messages or other interface actions, through the network interface 1904 to an Intranet or the Internet 1930. In the Internet example, software components or services may reside on multiple different computer systems 1910 or servers 1931 across the network. Software components described above may be implemented on one or more servers. A server 1931 may transmit messages from one component, through Internet 1930, local network 1920, and network interface 1904 to a component or container on computer system 1910, for example. Software components of a composite application may be implemented on the same system as other components, or on a different machine than other software components. This process of sending and receiving information between software components or one or more containers may be applied to communication between computer system 1910 and any of the servers 1931 to 1935 in either direction. It may also be applied to communication between any two servers 1931 to 1935.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method comprising:
receiving, in a computer system, a plurality of bills of materials (BOMs), wherein the plurality of BOMs are associated with a plurality of corresponding products and a plurality of corresponding low-level codes; wherein the low-level codes classify the plurality of products according to a plurality of manufacturing levels;
sorting, in the computer system, the BOMs according to the plurality of corresponding low-level codes into an order;
scanning, in the computer system, through the plurality of corresponding low-level codes incrementally in the order to determine a first portion of the plurality of BOMs associated with a first product in the plurality of products;
determining, in the computer system, a first portion of the plurality of corresponding low-level codes associated with the first portion of the plurality of BOMs;
determining, in the computer system, a lowest low-level code in the first portion of the plurality of corresponding low-level codes; and
associating, in the computer system, the lowest low-level code in the first portion of the plurality of corresponding low-level codes with each of the first portion of the plurality of BOMs.

2. The method of claim 1 further comprising:
scanning, in the computer system, through the plurality of corresponding low-level codes incrementally in the order to determine a second portion of the plurality of BOMs associated with second product in the plurality of products;
determining, in the computer system, a second portion of the plurality of corresponding low-level codes associated with the second portion of the plurality of BOMs;
determining, in the computer system, a lowest low-level code in the second portion of the plurality of corresponding low-level codes; and
associating, in the computer system, the lowest low-level code in the second portion of the plurality of corresponding low-level codes with each of the second portion of the plurality of BOMs.

3. The method of claim 1 further comprising:
scanning, in the computer system, through the plurality of corresponding low-level codes incrementally in the order to determine a second portion of the plurality of BOMs having the first product in the plurality of products as a component;
determining, in the computer system, a second portion of the plurality of corresponding low-level codes associated with the second portion of the plurality of BOMs;
determining, in the computer system, a lowest low-level code in the second portion of the plurality of corresponding low-level codes; and
associating, in the computer system, the lowest low-level code in the second portion of the plurality of corresponding low-level codes with each of the first portion of the plurality of BOMs.

4. The method of claim 1 wherein the order ascends from a low manufacturing level value to a high manufacturing level value.

5. A method of claim 1 wherein the lowest low-level code in the first portion of the plurality of corresponding low-level codes is used for determination of eligibility for preferential customs duty for the first product or another product in the plurality of products.

6. The method of claim 1 wherein the plurality of BOMs are received from a plurality of different sources, and wherein the plurality of manufacturing levels differ from one another according to the different sources.

7. A method of claim 1 wherein at least one of the plurality of BOMS associated with a first corresponding product in the plurality of corresponding products comprises a second corresponding product in the plurality of corresponding products as a component.

8. A non-transitory computer-readable storage medium containing instructions that, when executed, control a computer processor to be configured for:
receiving a plurality of bills of materials (BOMs), wherein the plurality of BOMs are associated with a plurality of corresponding products and a plurality of corresponding low-level codes; wherein the low-level codes classify the plurality of products according to a plurality of manufacturing levels;
sorting the BOMs according to the plurality of corresponding low-level codes into an order;
scanning through the plurality of corresponding low-level codes incrementally in the order to determine a first portion of the plurality of BOMs associated with a first product in the plurality of products;
determining a first portion of the plurality of corresponding low-level codes associated with the first portion of the plurality of BOMs;
determining a lowest low-level code in the first portion of the plurality of corresponding low-level codes; and
associating the lowest low-level code in the first portion of the plurality of corresponding low-level codes with each of the first portion of the plurality of BOMs.

9. The non-transitory computer-readable storage medium of claim 8 further containing instructions that, when executed, control the computer processor to be configured for:
scanning through the plurality of corresponding low-level codes incrementally in the order to determine a second portion of the plurality of BOMs associated with second product in the plurality of products;
determining a second portion of the plurality of corresponding low-level codes associated with the second portion of the plurality of BOMs;
determining a lowest low-level code in the second portion of the plurality of corresponding low-level codes; and
associating the lowest low-level code in the second portion of the plurality of corresponding low-level codes with each of the second portion of the plurality of BOMs.

10. The non-transitory computer-readable storage medium of claim 8 further containing instructions that, when executed, control the computer processor to be configured for:
scanning through the plurality of corresponding low-level codes incrementally in the order to determine a second portion of the plurality of BOMs having the first product in the plurality of products as a component;
determining a second portion of the plurality of corresponding low-level codes associated with the second portion of the plurality of BOMs;
determining a lowest low-level code in the second portion of the plurality of corresponding low-level codes; and
associating the lowest low-level code in the second portion of the plurality of corresponding low-level codes with each of the first portion of the plurality of BOMs.

11. The non-transitory computer-readable storage medium of claim 8 wherein the order ascends from a low manufacturing level value to a high manufacturing level value.

12. The non-transitory computer-readable storage medium of claim 8 wherein the lowest low-level code in the first portion of the plurality of corresponding low-level codes is used for determination of preferential customs duty for the first product or another product in the plurality of products.

13. The non-transitory computer-readable storage medium of claim 8 wherein the plurality of BOMs are received from a plurality of different sources, and wherein the plurality of manufacturing levels differ from one another according to the different sources.

14. A non-transitory computer-readable storage medium of claim 8 wherein at least one of the plurality of BOMS associated with a first corresponding product in the plurality of corresponding products comprises a second corresponding product in the plurality of corresponding products as a component.

15. A system comprising:
one or more computer processors; and
a non-transitory computer-readable storage medium containing instructions, that when executed, control the one or more computer processors to be configured for:
receiving a plurality of bills of materials (BOMs), wherein the plurality of BOMs are associated with a plurality of corresponding products and a plurality of corresponding low-level codes; wherein the low-level codes classify the plurality of products according to a plurality of manufacturing levels;
sorting the BOMs according to the plurality of corresponding low-level codes into an order;
scanning through the plurality of corresponding low-level codes incrementally in the order to determine a first portion of the plurality of BOMs associated with a first product in the plurality of products;
determining a first portion of the plurality of corresponding low-level codes associated with the first portion of the plurality of BOMs;
determining a lowest low-level code in the first portion of the plurality of corresponding low-level codes; and
associating the lowest low-level code in the first portion of the plurality of corresponding low-level codes with each of the first portion of the plurality of BOMs.

16. The system of claim 15 wherein the non-transitory computer-readable storage medium further contains instructions, that when executed, control the one or more computer processors to be configured for:
scanning through the plurality of corresponding low-level codes incrementally in the order to determine a second portion of the plurality of BOMs associated with second product in the plurality of products;
determining a second portion of the plurality of corresponding low-level codes associated with the second portion of the plurality of BOMs;
determining a lowest low-level code in the second portion of the plurality of corresponding low-level codes; and
associating the lowest low-level code in the second portion of the plurality of corresponding low-level codes with each of the second portion of the plurality of BOMs.

17. The system of claim 15 wherein the non-transitory computer-readable storage medium further contains instructions, that when executed, control the one or more computer processors to be configured for:
scanning through the plurality of corresponding low-level codes incrementally in the order to determine a second portion of the plurality of BOMs having the first product in the plurality of products as a component;
determining a second portion of the plurality of corresponding low-level codes associated with the second portion of the plurality of BOMs;
determining a lowest low-level code in the second portion of the plurality of corresponding low-level codes; and
associating the lowest low-level code in the second portion of the plurality of corresponding low-level codes with each of the first portion of the plurality of BOMs.

18. The system of claim 15 wherein the order ascends from a low manufacturing level value to a high manufacturing level value.

19. The system of claim 15 wherein the lowest low-level code in the first portion of the plurality of corresponding low-level codes is used for determination of eligibility for preferential customs duty for the first product or another product in the plurality of products.

20. The system of claim 15 wherein the plurality of BOMs are received from a plurality of different sources, and wherein the plurality of manufacturing levels differ from one another according to the different sources.
